(19) United States
(12) Patent Application Publication
(10) Pub. No.: US 2009/0072556 A1
(43) Pub. Date: Mar. 19, 2009

(54) Non-Opaque Radiator Grilles for Automotive Vehicles

(76) Inventors: Conrad Michael Kudelko, Livonia, MI (US); Gerald Frank Crawford, Chelsea, MI (US); Louis Matthew Caballero, Saline, MI (US)

Correspondence Address: MILLER LAW GROUP, PLLC;AND FORD GLOBAL TECHNOLOGIES, INC., 25 STEVENS AVENUE, WEST LAWN, PA, 19609, US

(21) Appl. No.: 11/856,048

(22) Filed: Sep. 16, 2007

(51) Int. Cl. B60R 19/52

(52) U.S. Cl. 293/115

(57) ABSTRACT

A non-opaque radiator grille is deployed on an automotive vehicle. The use of non-opaque materials enables the radiator grille to incorporate a variety of different features for styling distinctions, including low visibility illumination, frosting, graphics, ribbing, fluting or other texturing. The grille can be treated or textured on an interior surface of the material to provide the desired textured look, instead of on the exterior surface. The non-opaque grille can be liquid filled, sand blasted and/or incorporate luminescence or diffused lighting. A single grille configuration can be treated internally to provide different styling looks for model or series differentiations. The non-opaque nature of the grille material opens the grille for sensing technology to be incorporated directly into the grille. If secondary external treatment processes are still desired, the use of the non-opaque materials would not prevent the chroming or painting of the radiator grilles.

### FIELD OF THE INVENTION

This invention relates generally to the radiator grilles for automobiles and, more particularly, to a non-opaque grille structure that provides a decorative function for the vehicle.

### BACKGROUND OF THE INVENTION

Presently, the automotive industry is employing opaque radiator grilles that are either chromed, painted to match the body color of the vehicle, or molded in an accent color, such as black. Achieving a body matching color for styling purposes is costly, but is has proven to be important in the view of the consumer. Thus, automotive manufacturers are providing radiator grilles that match the color of the vehicle body to remain competitive with the other manufacturers. Other than primarily directing air flow onto the radiator, the radiator grille performs little other function than decoration. Providing decorative radiator grilles, however, can be rather costly. For example, in a vehicle model in which twelve body colors are provided as an option to the consumer, the manufacturer must keep in inventory a corresponding twelve uniquely painted radiator grilles. Accordingly, it would be desirable to reduce the costs associated with the overall radiator grille costs, yet maintain a competitive styling and marketing image to the consumers.

In U.S. Pat. No. 4,977,695, granted to Joseph Armbruster on Dec. 18, 1990, an illuminated medallion is deployed on the radiator grille to provide decoration for the front of the vehicle. The Armbruster medallion has a translucent or transparent plastic diffusion panel or cover that allows the passage of light from a bulb mounted within the medallion. Similarly, an illuminated emblem comprised of a plastic housing covered by a translucent or transparent cover to allow the diffusion from a light bulb mounted in the housing and illuminate the emblem is disclosed in U.S. Pat. No. 6,190,026, issued on Feb. 20, 2001, to Matthew Moore. However, an illuminated emblem or medallion is not a radiator grille, but a decoration that can be mounted on or near a radiator grille of a vehicle.

Illuminated decorative emblems are not confined to the front of the vehicle. As can be seen in U.S. Pat. Publication No. 2002/0105812, by Werner Zimmerman, published on Aug. 8, 2002, on a patent application filed in the U. S. on Dec. 10, 2001. In the Zimmerman patent publication, the illuminated emblem is located on the trunk lid of the automotive vehicle and is formed with a light-transmissive plastic material to allow the illumination of the emblem from LEDs or other light sources housed below the light-transmissive lens covering. In U.S. Pat. Publication No. 2006/0104074, published on May 18, 2006, from a U.S. Pat. Application filed on Sep. 10, 2004, by Robert Boniface, et al, a similar lighted emblem is shown to be deployed on the radiator grille or on the rear trunk lid.

In U.S. Pat. No. 4,310,872, issued to Henry de S. Lauve on Jan. 12, 1982, a front end for an automotive vehicle is disclosed in which an airfoil band 42 is disposed on the front grille area of the vehicle. The airfoil band is fabricated from clean, untinted glass or plastic that makes the structure beneath the band invisible to the casual observer whether in day or in night. The clear band also allows the light from the headlamps to pass through. A transparent deflector shield is mounted on the front of a vehicle at the radiator grille in U.S. Pat. No. 4,627,657, granted on Dec. 9, 1986, to John Daniels to deflect insects away from the windshield of the vehicle.

None of the known prior art discloses a radiator grille formed of non-opaque material that would provide many decorative opportunities in the styling of the automotive vehicle. Accordingly, it would be desirable to provide a non-opaque radiator grille for deployment on any automotive vehicle.

### SUMMARY OF THE INVENTION

It is an object of this invention to overcome the aforementioned disadvantages of the known prior art by providing a non-opaque radiator grille for deployment on the forward end of an automotive vehicle to provide the operative function of directing the flow of air onto the radiator, while providing a variety of styling opportunities for the vehicle.

It is another object of this invention to provide a radiator grille that is cooperative with sensor technology.

It is an advantage of this invention that the use of non-opaque radiator grilles will result in a reduced cost for an automobile manufacturer.

It is a feature of this invention that the non-opaque radiator grille can be treated in a variety of ways to provide a differentiation in series or models of vehicles.

It is another feature of this invention that the non-opaque radiator grille can be adapted with low visibility illumination or carbon fiber or fiberglass mesh graphics that will provide a unique ornamentation for the vehicle.

It is another advantage of this invention that the use of non-opaque materials for the construction of a radiator grille enables stress risers, defects and knit lines to be more visible to improve quality in radiator grilles.

It is still another feature of this invention that the radiator grille can be color-keyed to adjacent structural components of the vehicle, such as lamps, housings and bug deflectors.

It is still another advantage of this invention that the manufacture of the radiator grille can be accomplished in a single step without requiring secondary processes to paint the exterior surface of the grille.

It is still another advantage of this invention that the lack of secondary processes in the manufacture of the radiator grille provides a more predictable end result by avoiding aberrations due to chroming and painting and avoids chrome reflection and the burning of adjacent parts.

It is yet another advantage of this invention that secondary finishing processes, such as painting or chroming, can be optionally provided even when using non-opaque materials to construct the radiator grille.

It is yet another feature of this invention that the non-opaque radiator grille can incorporate luminescent lighting technologies, or be provided with diffused lighting.

It is still another advantage of this invention that the non-opaque radiator grille can be surface treated on the internal surface of the grille material to provide a textured grille look while maintaining a smooth exterior surface.

It is yet another advantage of this invention that the radiator grille can be co-injected with light/dark plastic materials.

It is a further advantage of this invention that the lack of exterior surface treating, such as chroming or painting, eliminates the exposure of the radiator grille to color degradation due to stone impingement.

It is still a further advantage of this invention that the lack of exterior surface treating, such as chroming or painting, makes recycling of the grille easier to accomplish.

It is yet another feature of this invention that the non-opaque radiator grille can be formed with ribbing, fluting or lamp-like optics to provide distinctions in appearance.

It is a further object of this invention to provide a non-opaque radiator grille for an automotive vehicle that is durable in construction, inexpensive of manufacture, carefree of maintenance, facile in assemblage, and simple and effective in use.

These and other objects, features and advantages are accomplished according to the instant invention by providing a non-opaque radiator grille for deployment on an automotive vehicle. The use of non-opaque materials enables the radiator grille to incorporate a variety of different features for styling distinctions, including low visibility illumination, frosting, graphics, ribbing, fluting or other texturing. The grille can be treated or textured on an interior surface of the material to provide the desired textured look, instead of on the exterior surface. The non-opaque grille can be liquid filled, sand blasted and/or incorporate luminescence or diffused lighting. A single grille configuration can be treated internally to provide different styling looks for model or series differentiations. The non-opaque nature of the grille material opens the grille for sensing technology to be incorporated directly into the grille. If secondary external treatment processes are still desired, the use of the non-opaque materials would not prevent the chroming or painting of the radiator grilles.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1A is a perspective view of a radiator grille for an automobile incorporating the principles of the instant invention;

FIG. 1B is an enlarged partial view of the radiator grille of FIG. 1A corresponding to the circle A in FIG. 1A, and incorporating a first embodiment of the instant invention to provide a textured surface on a select portion of the exterior of the radiator grille;

FIG. 1C is an enlarged partial view of the radiator grille similar to that of FIG. 1B, but depicting the exterior textured surface treatment placed on a different part of the grille structure;

FIG. 2A is a perspective view of a radiator grille for an automobile incorporating the principles of the instant invention;

FIG. 2B is an enlarged partial view of the radiator grille of FIG. 2A corresponding to the circle A in FIG. 2A, and incorporating a second embodiment of the instant invention to provide a textured surface on a select portion of the interior of the radiator grille;

FIG. 2C is an enlarged partial view of the radiator grille similar to that of FIG. 2B, but depicting the interior textured surface treatment placed on a different part of the grille structure;

FIG. 3A is a perspective view of a radiator grille for an automobile incorporating the principles of the instant invention;

FIG. 3B is an enlarged partial view of the radiator grille of FIG. 3A corresponding to the circle A in FIG. 3A, and incorporating a third embodiment of the instant invention to provide a bubbled appearance on a select portion of the radiator grille;

FIG. 3C is an enlarged partial view of the radiator grille similar to that of FIG. 3B, but depicting the bubbled appearance for the grille structure;

FIG. 4A is a perspective view of a radiator grille for an automobile incorporating the principles of the instant invention;

FIG. 4B is an enlarged partial view of the radiator grille of FIG. 4A corresponding to the circle A in FIG. 4A, and incorporating a fourth embodiment of the instant invention to provide a portion of the radiator grille filled with liquid, gas or other media;

FIG. 4C is an enlarged partial view of the radiator grille similar to that of FIG. 4B, but depicting the different part of the grille structure that is filled with liquid, gas or other media;

FIG. 5A is a perspective view of a radiator grille for an automobile incorporating the principles of the instant invention;

FIG. 5B is an enlarged partial view of the radiator grille of FIG. 5A corresponding to the circle A in FIG. 5A, and incorporating a fifth embodiment of the instant invention to provide carbon fiber or fiberglass mesh graphics within or on a select portion of the radiator grille;

FIG. 5C is an enlarged partial view of the radiator grille similar to that of FIG. 5B, but depicting carbon fiber or fiberglass mesh being placed at a different part of the grille structure;

FIG. 6A is a perspective view of a radiator grille for an automobile incorporating the principles of the instant invention;

FIG. 6B is an enlarged partial view of the radiator grille of FIG. 6A corresponding to the circle A in FIG. 6A, and incorporating a sixth embodiment of the instant invention to provide a ribbing or fluting on a select portion of the interior or exterior of the radiator grille;

FIG. 6C is an enlarged partial view of the radiator grille similar to that of FIG. 6B, but depicting the ribbing or fluting being associated with a different part of the grille structure;

FIG. 7 is a perspective view of a radiator grille for an automobile in which the non-opaque grille has been co-injected with light and dark plastics to provide a distinctive styling appearance for the grille;

FIG. 8 is a perspective view of a radiator grille for an automobile in which the non-opaque grille is associated with a low visibility diffused or luminescent lighting on selected portions of the grille;

FIG. 9 is an enlarged portion of the radiator grille to reflect the ease of identifying defects, such as stress risers and knit lines in the grille structure;

FIG. 10 is an enlarged portion of the radiator grille incorporating the principles of the instant invention to be associated with sensor technologies;

FIGS. 11-16 are perspective representations of emblems that can be formed from non-opaque material to incorporate the same treatments reflected in FIGS. 1-6 above; and

FIGS. 17-20 depict the utilization of the principles of the instant invention on grilles found on the front, rear, top and sides of the automotive vehicle on which the instant invention is deployed.

### DETAILED DESCRIPTION OF THE PREFERRED EMBODIMENT

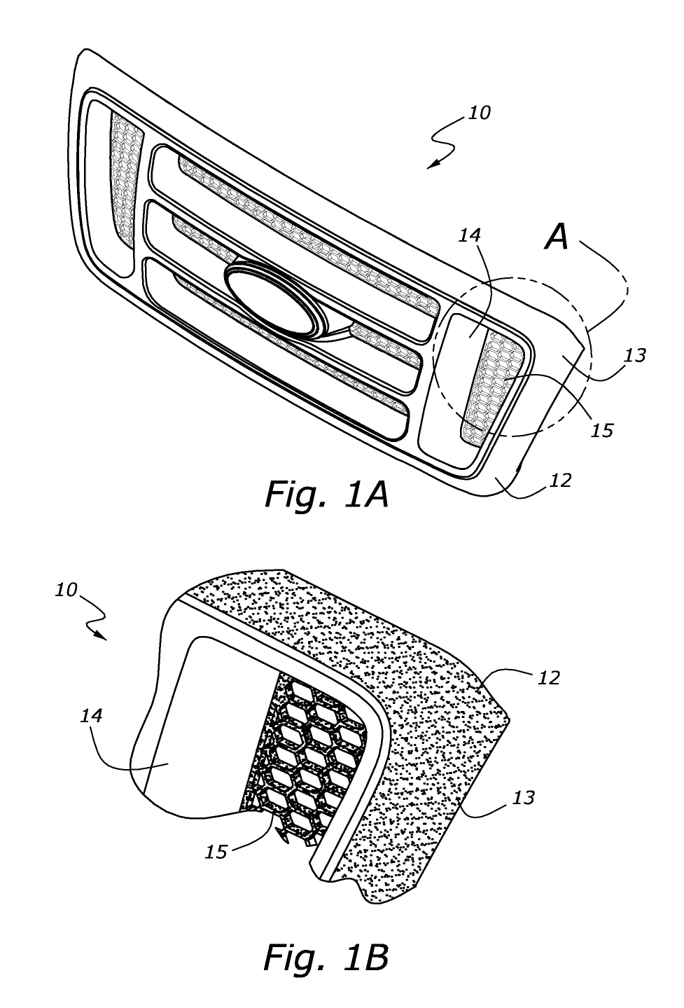

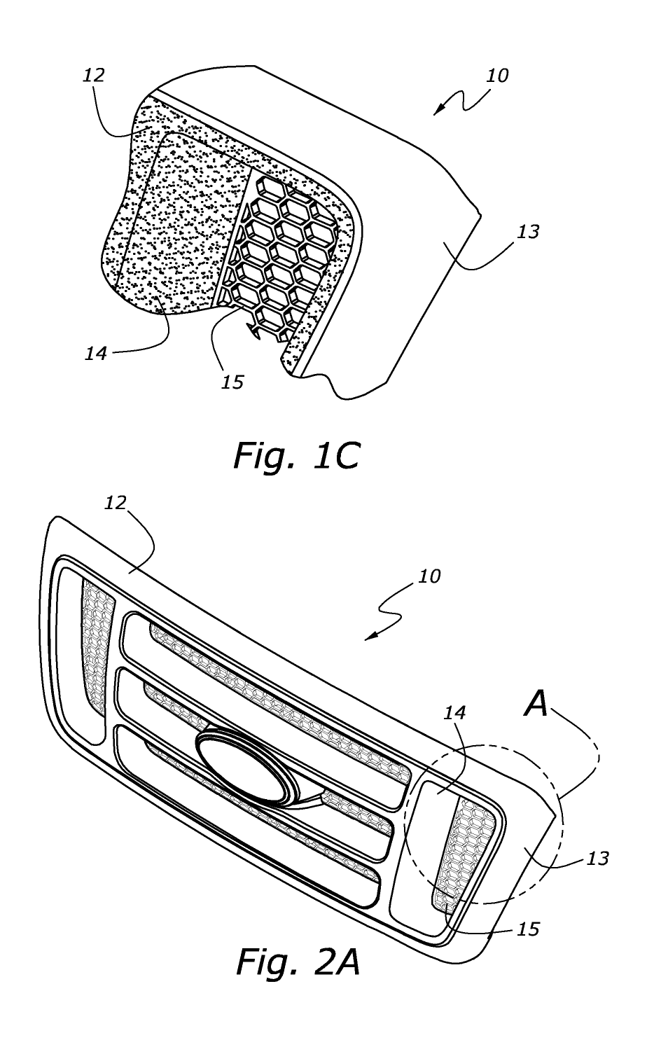

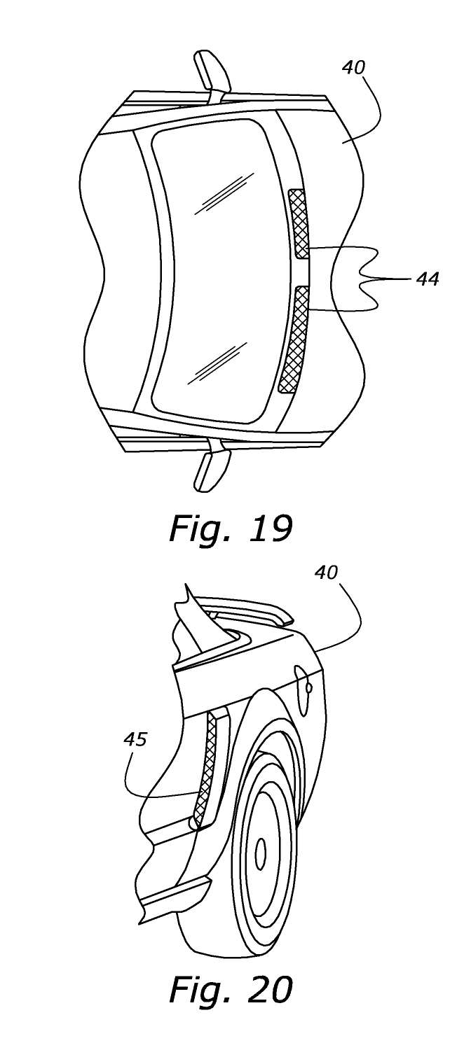

Referring to FIGS. 1A-20, a radiator grille for deployment on an automotive vehicle and incorporating the principles of the instant invention can best be seen. The body of the radiator grille 10 is formed of non-opaque plastic material, such as ABS or polycarbonate, and may be formed as a hollow body, to define and interior surface and an exterior surface shaped into the desired shape or configuration, such as the radiator grille 10 shown in FIGS. 1A-6C, which can be utilized on a sport utility vehicle (SUV). The radiator grille 10 is preferably injection molded, but could be formed through rotational molding techniques, as well. Furthermore, portions of the radiator grille 10 could be extruded. During the formation of the radiator grille, or once the radiator grille 10 is formed, from non-opaque material, the grille 10 can be subjected to a variety of different treatments to obtain the desired appearance for the styling considerations placed on a particular vehicle, or series or model of vehicle.

A first treatment for the radiator grille 10 is depicted in FIGS. 1A-1C and corresponds to a textured exterior surface 12 for all or selected portions of the grille structure. Treatment of the exterior surface 12 could include a frosting appearance that can be obtained through sand blasting. Other treatment options could include a graining or dimpling, or other specific texture placed onto the exterior surface 12. Another treatment is no treatment at all, which can provide a clear, translucent appearance to the radiator grille 10. As is reflected in a comparison between FIGS. 1B and 1C, the treatment to the exterior surface can be applied to selected portions, such as the outer band 13 or the grille mesh 15, as is shown in FIG. 1B, or to the interior band portions 14 of the grille 10, as is depicted in FIG. 1C.

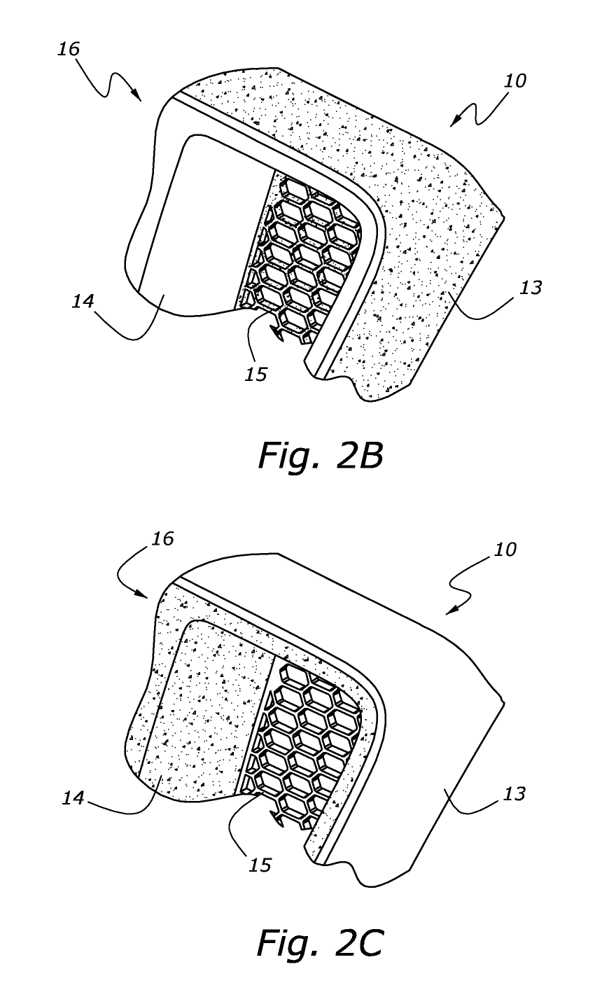

Since the grille 10 is non-opaque, a frosted appearance can also be attained by treating the interior surface of the grille structure 10, leaving the exterior surface 12 smooth so that the exterior surface will not accumulate extraneous materials, such as a buildup of car wax. Substantially the same treatments that can be made to the exterior surface 12 can be made to the interior surface 16 of the grille, including graining, dimpling, sand blasting, etc. to provide the desired styling appearance. As with the exterior surface treatments depicted in FIGS. 1B-1C, the interior surface treatments shown in FIGS. 2B-2C can be placed on all of the interior surface 16 or just on selected portions of the interior surface 16, such as the outer band 13 or the interior band portions 14.

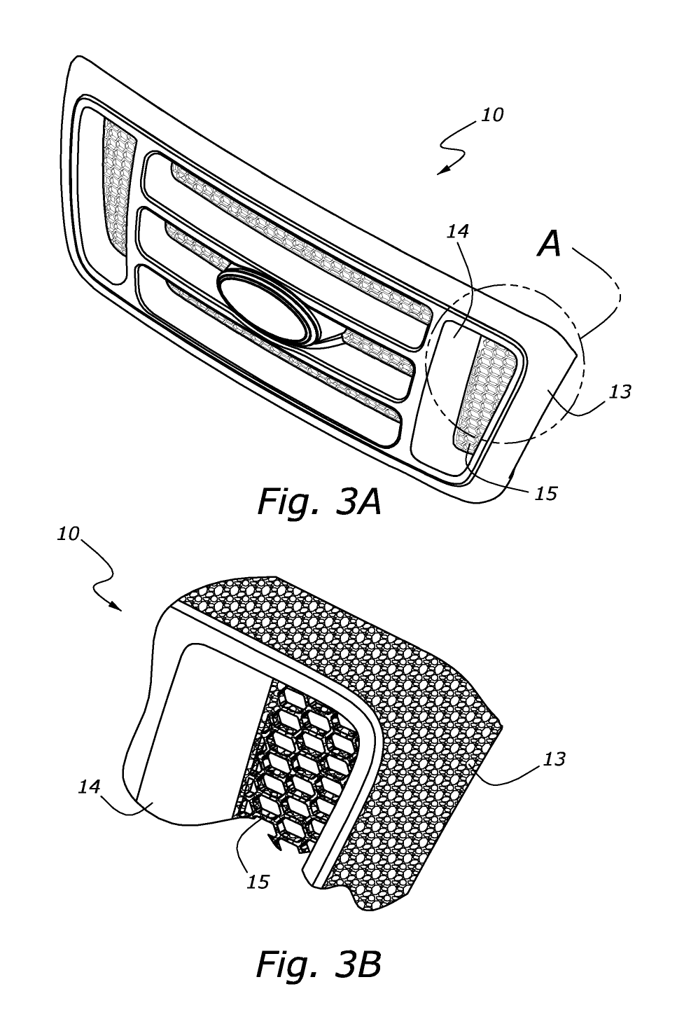

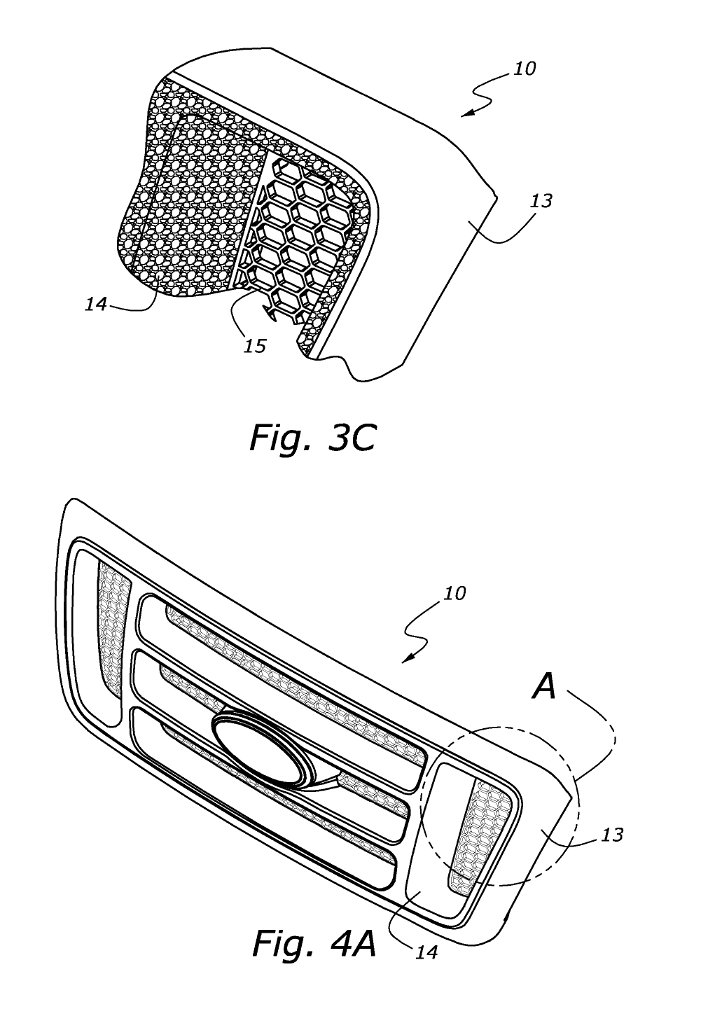

As is reflected in FIGS. 3A-3C, the grille structure 10 can be formed with internal bubbles placed in a regular pattern to provide a styling appearance that cannot be obtained with conventional opaque radiator grilles. As with the surface treatments represented in FIGS. 1A-2C, the internal bubbles formed in the grille structure 10 can be placed into all of the grille structure 10 or into only selected portions of the grille structure 10, such as the outer band 14 and/or grille mesh 15, as depicted in FIG. 3B, or on the interior band 14 as is depicted in FIG. 3C.

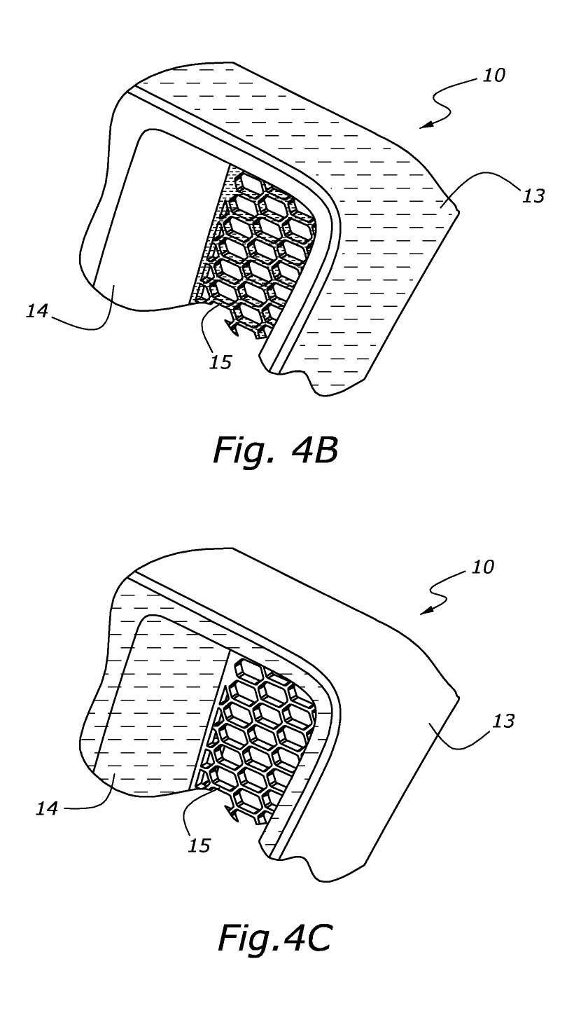

If the radiator grille 10 is formed as a hollow body, the interior can be filled with liquid, gas or other media, as is depicted in FIGS. 4A-4C, such as with a colored liquid that provides the desired styling characteristics desired for the particular vehicle. By internally compartmentalizing the interior of the hollow body radiator grille structure 10 with internal walls or baffles, selected portions of the grille structure 10 can be liquid filled, such as the outer band 13 as shown in FIG. 4B, or the interior band 14 as shown on FIG. 4C, instead of the entire grille structure 10. Since the grille mesh 15 can also be formed as a hollow, watertight body, the grille mesh 15 can also be separately filled with liquid, gas or other media, as is depicted in FIG. 4B.

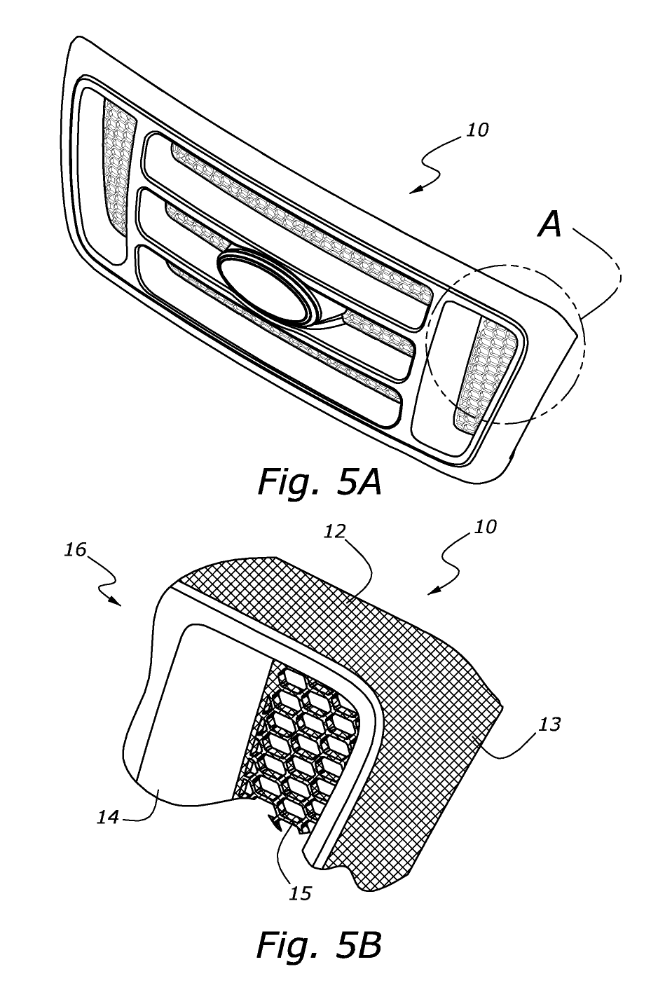

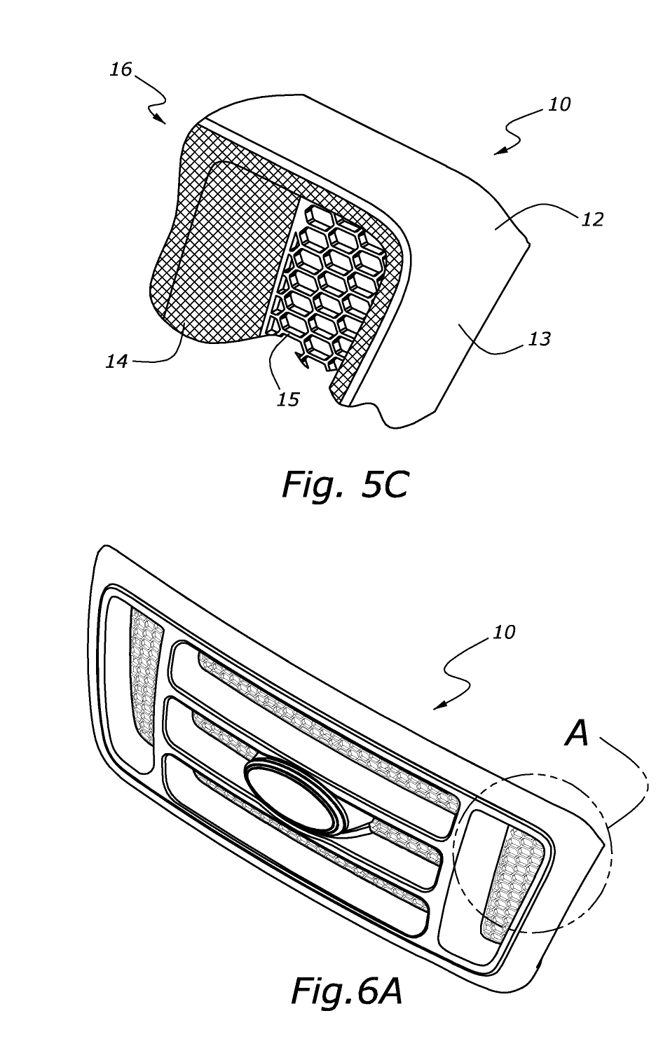

Yet another treatment that can be applied to either the exterior 12 or interior 16 surfaces of the grille structure 10, or embedded within the plastic material, are carbon fiber graphics or fiberglass mesh graphics, as is represented in FIGS. 5A-5C. With applied graphics, many different appearances can be obtained, including fresnel, smoked glass, amber, marble, metallics, chrome, faceted, geometries, etc. As with the other surface treatments, the graphics can be applied to the entire grille, within the material forming the grille or on the surface, or to selected parts, such as the outer band 13 and grille mesh 15 shown in FIG. 5B, or the interior band as shown in FIG. 5C.

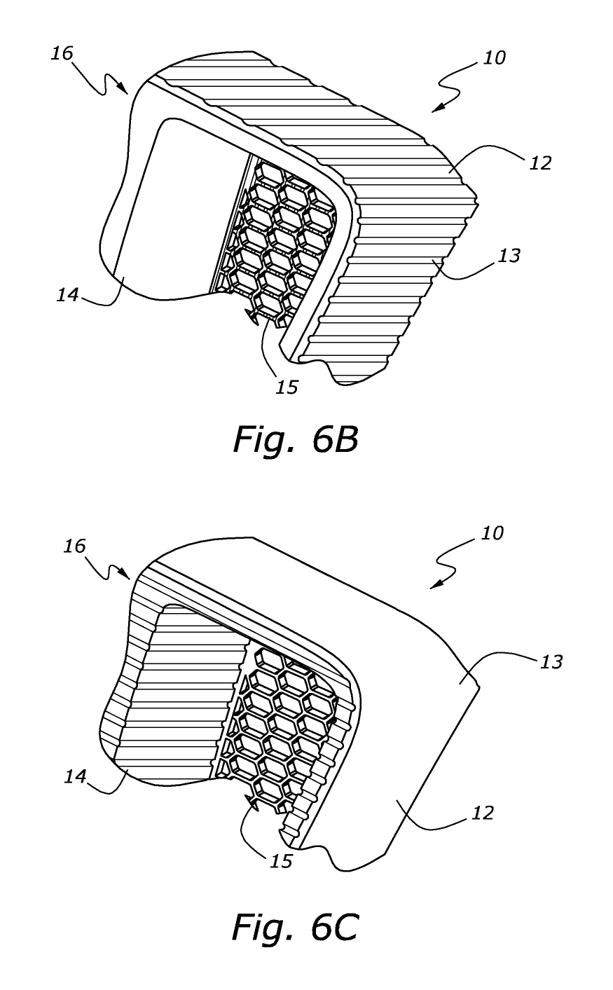

With the radiator grille structure 10 being injection molded, the mold can be configured to incorporate structural alterations into the plastic body of the grille 10 into either the interior 16 or exterior 12 surfaces. Such physical structural alterations, as are represented in FIGS. 6A-6C, can include ribbing, fluting or lamp-like optics. As with the other treatments, the physical structural alterations can be formed into all of the radiator grille structure 10 in a desired configuration, or only to selected portions of the grille 10, such as the outer band 13 and/or grille mesh 15 shown in FIG. 6B, or the interior band 6C as shown in FIG. 6C.

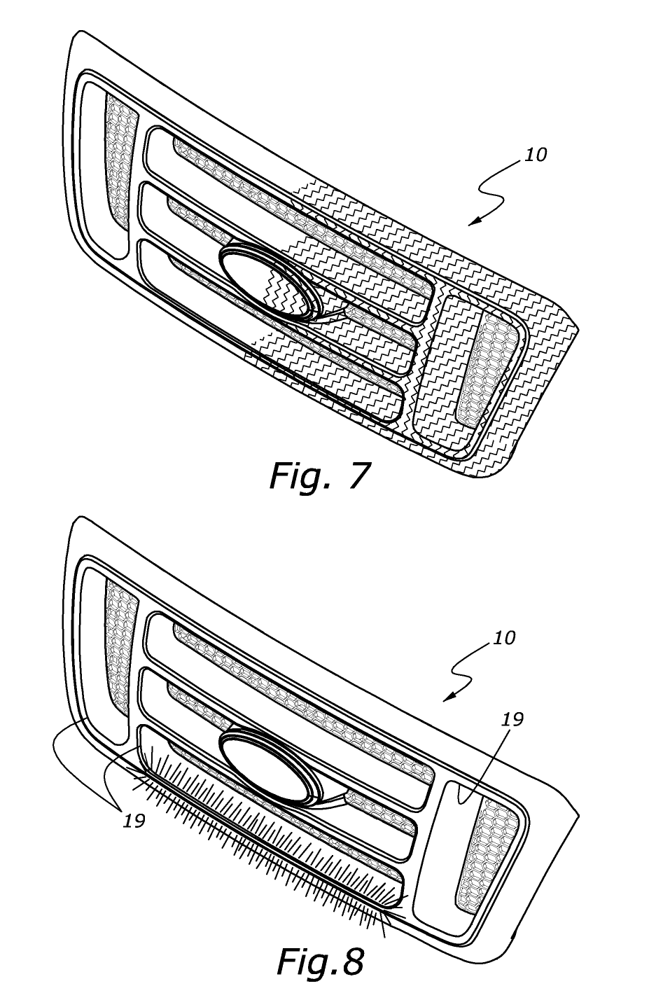

The use of injection molding techniques to manufacture the radiator grille 10 incorporating the principles of the instant invention also provide the opportunity to incorporate the co-injection of light and dark plastic materials into the structure of the grille 10 to establish a specific styling characteristic, as is represented in FIG. 7.

A great amount of flexibility in the styling appearance of the radiator grille 10 can come through the use of low visibility lighting techniques. Since the grille 10 is formed from non-opaque plastic material, such as polycarbonate, many lighting technologies, including fiber optics, bulb lighting, LED's, can be utilized. The lighting techniques can be selectively applied internally to the entire grille structure 10 on to specific surfaces or edges, such as around one or more grille pockets 19, as is depicted in FIG. 8. One skilled in the art will recognize that the low visibility light techniques can make the radiator grille glow, when the lighting is selectively operated, with substantially any color or colors desired. The lighting can be diffused, and/or the low visibility lighting techniques can incorporate luminescence technology.

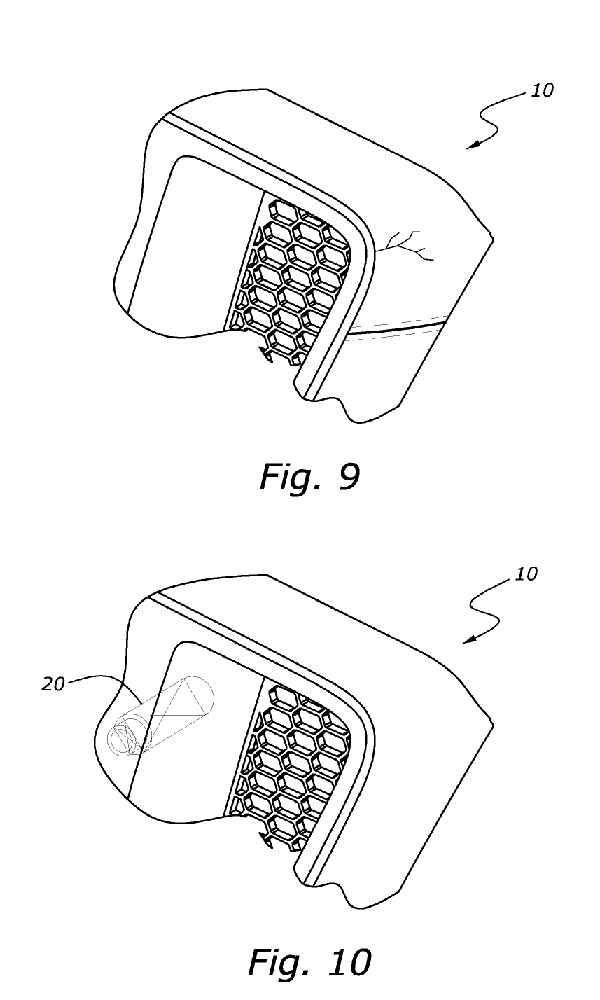

The use of non-opaque plastic materials in the manufacture of radiator grilles 10 make the observance of defects, such as stress risers, knit lines, etc. in the grille structure, as is depicted in FIG. 9. Accordingly, quality measurements can be improved for radiator grilles. With the non-opaque attributes of the radiator grille 10, sensors 20 can be built into the grille structure 10 to open the way for sensor technology to be incorporated into radiator grilles 10, as is represented in FIG. 10.

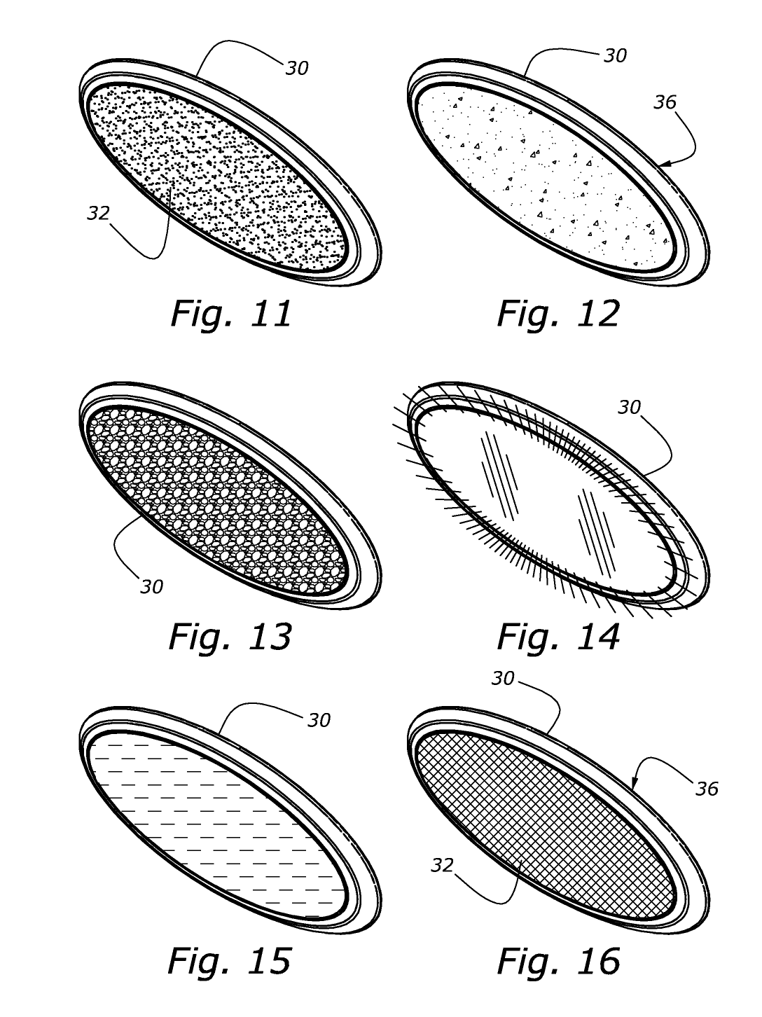

Injection molding the emblems 30 or other supplementary ornamentation placed on a vehicle from non-opaque materials, as is described above with respect to the radiator grilles 10, enables the same treatments described above in FIGS. 1A-6C to be applied to the emblems 30, thus providing matching emblem 30 styling characteristics. In FIG. 11, the outer surface 32 of the emblem 30 is physically treated. In FIG. 12, the interior surface 36 of the emblem 30 is similarly treated. In FIG. 13, the internal structure of the emblem 30 is formed with a regular pattern of bubbles. In FIG. 14, low visibility lighting technologies is applied to the emblem 30. In FIG. 15, the emblem 30 is formed as a watertight hollow body which can be liquid filled. Also, as is represented in FIG. 16, the emblem can be treated with graphics, buried within the emblem material or applied to the surface thereof, such as carbon fiber or fiberglass mesh graphics.

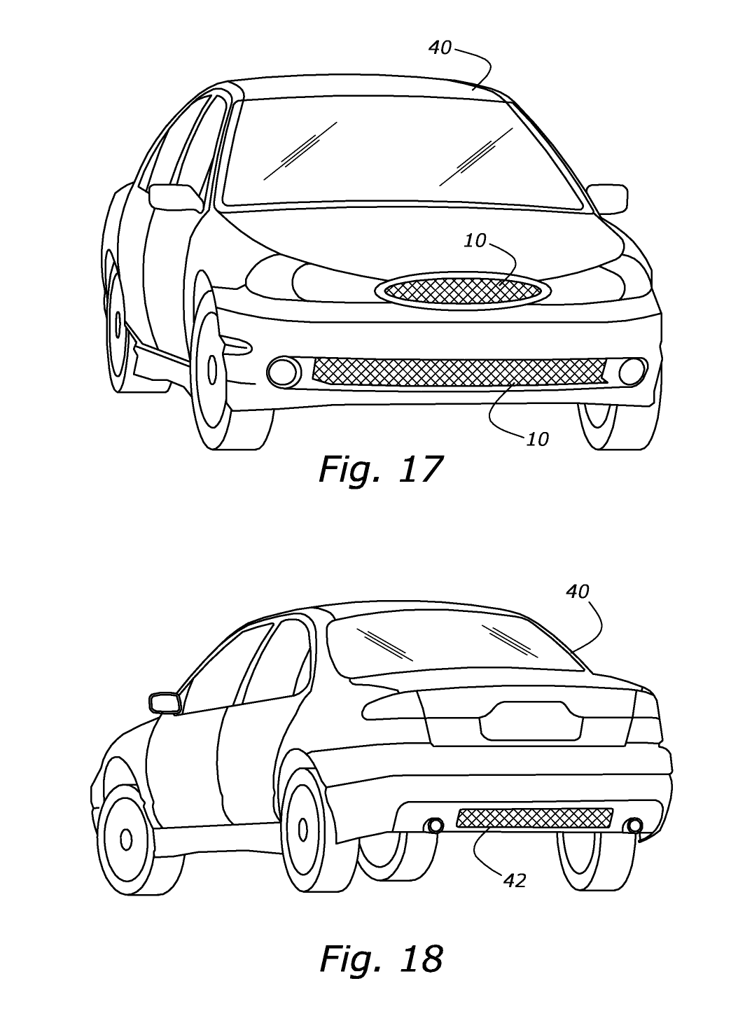

As is best seen in FIGS. 17-20, all of the external vehicle grilles 42 associated with parts of the vehicle 40 other than the radiator can also be formed in accordance with the principles of the instant invention, including air intake grilles 44, 45. These external and air intake grilles 42, 44, 45 can be color coded or treated to correspond to the part of the vehicle on which the grille 42, 44, 45 is deployed.

The formation of the grilles for an automotive vehicle according to the principles of the instant invention can easily provide an in-series or model differentiation. The grilles provide a unique look and present a lightweight and low cost alternative to conventional opaque chromed or painted grilles. The grilles can be manufactured in one piece or in multiple piece configurations. With no chrome or paint surface on the exterior of the grille, there is no opportunity for stone impingement to cause a degradation of the surface appearance of the grille. Furthermore, without the extra chrome or paint surface to be added to the grille, the manufacturing process for the grille is much simpler, and the recycling of the grille is easier without the need to strip the chrome or paint surface. Of course, if the chroming or painting of the exterior surface is still desired, the formation of the grille 10 from non-opaque plastic materials will not prevent this added processing step from being accomplished.

One skilled in the art will understand that each of the treatments described above are not mutually exclusive. In fact, two or more of the described treatments may be used simultaneously on the grille. For example, either the interior or exterior surfaces could be physically altered by sandblasting to achieve a frosted appearance for the grille, while low visibility lighting techniques are applied to provide a desired color effect for the grille. Other combinations of treatments will be equally combinable to provide the aesthetic appearance desired for the grille, and/or to provide in-series differentiation.

It will be understood that changes in the details, materials, steps, processes and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

1. (canceled)

2. A radiator grille for an automotive vehicle comprising:
a body formed of non-opaque plastic defining an exterior surface exposed outwardly of the body and an opposing interior surface, one of at least a portion of said exterior surface and at least a portion of said interior surface having a treatment applied over said surface thereof to present a desired aesthetic appearance.

3. The radiator grille of claim 2 wherein said treatment is a physical alteration of said exterior or interior surface.

4. The radiator grille of claim 2 wherein said treatment is a graphic applied to said exterior or interior surface.

5. The radiator grille of claim 2 further comprising:
low visibility lighting applied internally to said body to make said body glow with light.

6. The radiator grille of claim 5 wherein said low visibility lighting is applied to selected portions of said body.

7. The radiator grille of claim 2 wherein said body is formed in a watertight hollow configuration, at least a portion of said body being filled with liquid.

8. (canceled)

9. The radiator grille of claim 3 wherein said structural alteration is ribbing formed into at least a portion of said exterior surface.

10. The radiator grille of claim 3 wherein said structural alteration is the formation of bubbles in said body.

11-12. (canceled)

13. An injection molded automotive grille comprising:
a formed body made from non-opaque plastic and defining an exterior surface exposed outwardly from said body and an opposing interior surface, said body having a treatment including a physical alteration of at least a portion of said interior surface to present a desired aesthetic appearance visible through said exterior surface.

14. The automotive grille of claim 13 wherein said treatment is a graphic applied to said at least a portion of said interior surface.

15. The automotive grille of claim 13 further comprising:
low visibility lighting applied internally to at least a portion of said body to make said at least one portion of said body glow with light.

16. The automotive grille of claim 13 wherein said body is further formed with ribbing formed into at least a portion of said exterior surface making a structural alteration into said at least a portion of said exterior surface.

17-18. (canceled)

19. A method of manufacturing an automotive grille having a body defining an exterior surface and an opposing interior surface, comprising the steps of:
injection molding said body from non-opaque plastic material:
physically altering one of at least a portion of said exterior surface and at least a portion of said interior surface; and
applying graphics over one of at least a portion of said exterior surface and at least a portion of said interior surface.

20. The method of claim 19 further comprising the step of:
installing low visibility lighting internally of said body so that at least a portion of said body is illuminated with low visibility lighting.
